(19) United States
(12) Patent Application Publication
(10) Pub. No.: US 2026/0301353 A1
(43) Pub. Date: Oct. 1, 2026

(54) ELECTRONIC DEVICE AND METHOD FOR MONITORING FOR PRESENCE OF AN OPTICAL ELEMENT

(71) Applicant: VALEO COMFORT AND DRIVING ASSISTANCE, Créteil (FR)

(72) Inventors: Tatiana Grulois, Créteil (FR); Pierre Mermillod, Créteil (FR)

(73) Assignee: VALEO COMFORT AND DRIVING ASSISTANCE, Créteil (FR)

(21) Appl. No.: 18/998,127

(22) PCT Filed: Jun. 28, 2023
(86) PCT No.: PCT/EP2023/067604

§ 371 Date: Jan. 24, 2025

(30) Foreign Application Priority Data
Jul. 26, 2022 (FR) FR2207691

(51) Int. Cl. G06V 10/141

(52) U.S. Cl. CPC G06V 10/141

(57) ABSTRACT

An electronic device includes an illuminating unit, an image-capturing unit and a control unit. The illuminating unit includes a light source and an optical element and is configured to generate a reference pattern at the exit of said optical element. The control unit is configured to analyze an image captured by the image-capturing unit. The control unit is configured to identify the reference pattern generated by the illuminating unit in the image captured by the image-capturing unit. A method to verify the presence of an optical element within such an electronic device is also described.

### TECHNICAL FIELD

The present invention relates to the technical field of imaging, and in particular image capture using an illuminator.

The invention more particularly relates to an electronic device comprising an illuminating unit, an image-capturing unit and a control unit.

It also relates to a method for monitoring for presence of an optical element using such an electronic device.

One particularly advantageous application of the invention is image capture in the passenger compartment of a motor vehicle.

### TECHNOLOGICAL BACKGROUND

Driver-monitoring cameras are increasingly used in the passenger compartment of motor vehicles. In this context in particular, it is known to couple an image-capturing unit to an illuminating unit in order to maintain a sufficient light level independently of the ambient light level.

In order to avoid discomforting any persons present in the vicinity of the device, it is known practice to use infrared light sources emitting light beams that are invisible to the human eye. However, under certain conditions, infrared sources can present a risk to the human eye if their brightness gets too high, especially since they do not trigger a protective reflex in persons subjected to the infrared illumination.

Conventionally, the light sources, and in particular the infrared light sources, of the illuminating units are coupled to an optical element, such as a diffuser, that plays the dual role of increasing angular spread and of reducing the luminous intensity of the beam emitted by the source and passing through the diffuser. Thus, it is necessary to configure the light source so that it generates a light beam having a high brightness, in order to maintain a sufficient luminous intensity downstream of the diffuser relative to the direction of propagation of the beam.

A risk to the human eye arises if the diffuser is defective, for example because it is absent, deformed or broken.

Solutions addressing the risk of diffuser failure do exist but require the addition of specific equipment, which takes up space and is expensive, this running counter to the current trend of miniaturization of imaging devices.

In addition, these solutions do not prevent certain types of damage to the diffuser, such as thermal damage (exposure to extreme heat for example) that may degrade its internal structure, and therefore adversely affect how well it performs its role diffusing and reducing luminous intensity, without altering its external structure.

### SUMMARY OF THE INVENTION

In this context, an electronic device comprising an illuminating unit, an image-capturing unit and a control unit is provided. The illuminating unit comprises a light source and an optical element, and is configured to generate a reference pattern at the exit of said optical element. The control unit is configured to analyze an image captured by the image-capturing unit.

It is proposed here to use the control unit to identify the reference pattern generated by the illuminating unit in the image captured by the image-capturing unit. Identification of the pattern by the control unit makes it possible to ensure that the optical element is indeed present and/or functional. This verification step does not require any additional parts other than those required for the imaging function to work.

According to one embodiment, the reference pattern generated at the exit of said optical element is a diffraction pattern. The optical element of the electronic device may for example comprise at least one diffractive element. The diffractive element may be designed to form the reference pattern, which is then a diffraction pattern.

The diffractive element of said optical element may be a circular or rectangular hole. The dimensions of the hole may be less than one wavelength of the light source.

In another embodiment, the reference pattern generated at the exit of said optical element is a hologram. The optical element of the electronic device may then for example comprise at least one holographic element.

The control unit may be configured to activate a protective measure if the reference pattern is not identified.

The protective measure may be complete or partial deactivation of the light source. In another embodiment, the protective measure may be activation of a degraded mode in which a brightness of the light source is reduced.

Furthermore, the optical element may be a diffuser. Such a diffuser is used to spread the beam in order to illuminate the field of view of the camera as much as possible.

Preferably, the light source operates in the infrared. It may comprise at least one vertical-cavity surface-emitting laser.

The invention also relates to a method for monitoring for the presence of an optical element in an electronic device comprising an illuminating unit, a control unit and an image-capturing unit, said illuminating unit comprising a light source and said optical element, the monitoring method comprising the following steps:
generating a reference pattern at the exit of the optical element by means of the illuminating unit;
capturing at least one image by means of the image-capturing unit;
analyzing, by means of the control unit, the captured image so as to identify the reference pattern.

The monitoring method may also comprise a protective measure if the reference pattern has not been identified in the step of analyzing the captured image.

This protective measure may be complete or partial deactivation of the light source of the illuminating unit.

In another embodiment, the protective measure is activation of a degraded mode in which a brightness of the light source is reduced.

The various features, variants and embodiments of the invention may be associated with one another in various combinations, provided that they are not mutually incompatible or exclusive.

### BRIEF DESCRIPTION OF THE FIGURES

In addition, various other features of the invention will become apparent from the accompanying description that is given with reference to the drawings, which illustrate non-limiting embodiments of the invention, and in which:

FIG. 1 is a schematic representation of an electronic device according to one embodiment of the invention,

FIG. 2 is a schematic representation of an image captured in the passenger compartment of a motor vehicle by the image-capturing unit and having the reference pattern of the embodiment schematically shown in FIG. 1 with a circular diffractive element,

FIG. 3 is a schematic representation of an image captured in the passenger compartment of a motor vehicle by the image-capturing unit and having the reference pattern of the embodiment schematically shown in FIG. 1 with a rectangular diffractive element,

FIG. 4 is a schematic representation of an optical element comprising a plurality of diffractive elements, and

FIG. 5 is a flowchart showing one example of a method for monitoring for presence of an optical element using an electronic device shown in FIG. 1.

It should be noted that in these figures structural and/or functional elements shared by the different variants may have the same reference signs.

### DETAILED DESCRIPTION

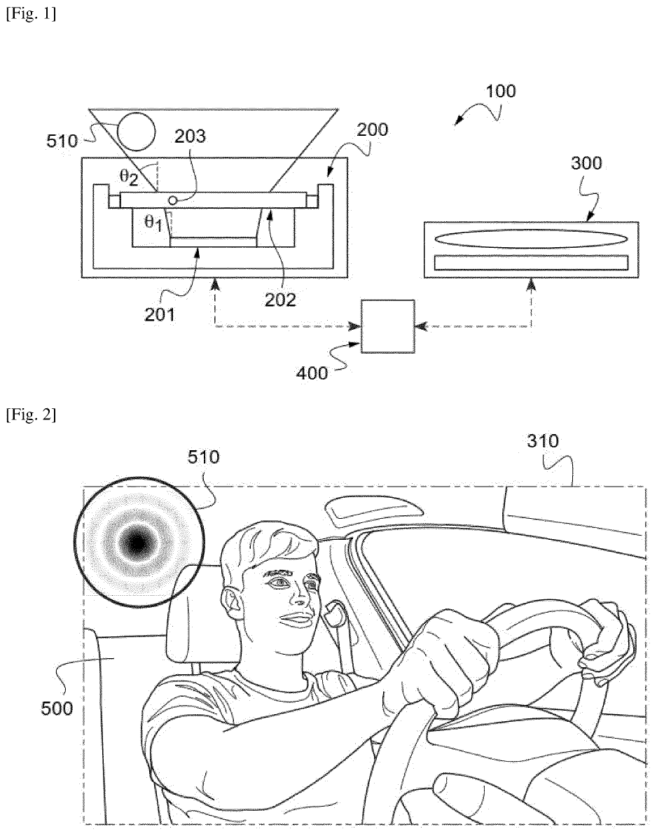

An electronic device according to the invention, as schematically shown in FIG. 1 and designated in its entirety by the reference 100, comprises an illuminating unit 200, an image-capturing unit 300 and a control unit 400 coupled to the illuminating unit 200 and to the image-capturing unit 300. The electronic device may be placed in a motor vehicle, for example in order to form a driver monitoring system (DMS).

The illuminating unit 200 comprises a light source 201 and an optical element 202.

The image-capturing unit 300 makes it possible to capture images of an environment facing it, here part of the passenger compartment 500 of the motor vehicle. For example, the field of view of the image-capturing unit 300 is directed toward the usual position of the driver. The image-capturing unit 300 may be a camera and capture the entire scene exposed by the illuminating unit 200. In particular, the image-capturing unit captures fixed elements of the passenger compartment 500 such as the ceiling.

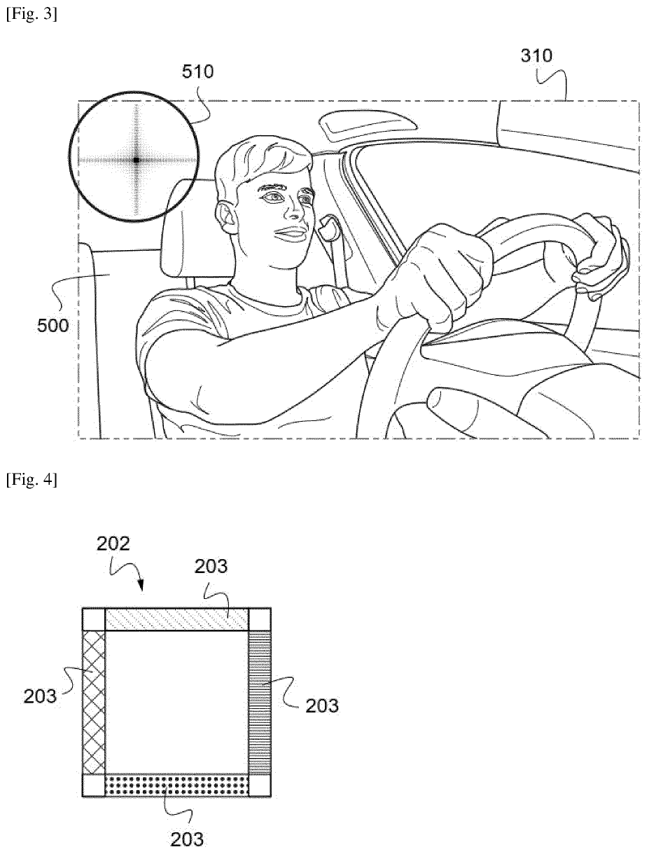

The control unit 400 is configured to analyze the captured image 310. Two examples of a captured image 310 in the embodiment shown in FIG. 1 are schematically shown in FIGS. 2 and 3.

In order to avoid discomforting persons present near the electronic device 100 and to make the image-capturing process the same both day and night, the light source 201 may operate in the infrared as infrared light is invisible to the human eye. The image-capturing unit 300 operates at least in the same wavelength range as the light source 201. Here, it operates in the infrared and visible.

The light source 201 may for example comprise at least one vertical-cavity surface-emitting laser. Vertical-cavity surface-emitting lasers (commonly referred to as VCSELs by a person skilled in the art) have a very low temperature drift and allow a beam to be generated in a very narrow wavelength band. In this case in particular, the light source 201 is coherent.

Furthermore, the ability of VCSELs to generate short pulses allows the peak power of the pulses to be increased and therefore the signal-to-noise ratio to be increased.

Such a light source 201 has a fairly low divergence, of the order of 15° to 20°. In order to illuminate a wider field of view (between 50° and 180° in the case of the passenger compartment 500 of the motor vehicle), the optical element 202 makes it possible to increase the value of the angular spread of the beam.

Thus, upstream of the optical element 202 relative to the direction of propagation of the beam, the beam has an angular spread having an upstream value θ₁. Downstream of said optical element 202, the light beam has an angular spread having a downstream value θ₂ greater than the upstream value θ₁.

In the electronic device 100 presented here, the optical element 202 is a diffuser. The diffuser may for example be a plate with a scattering coating. Alternatively, the diffuser may be a frosted plate or a plate composed of a scattering material or a microlens array (MLA) or it may itself be a diffractive optical element (DOE). In another embodiment, the optical element 202 may be a prism.

Through its spreading function, the optical element 202 disperses the beam and reduces its brightness. To maintain a sufficient level of brightness, the light source 201 is adjusted such that the intensity of the beam at the exit of the optical element 202 is about 20% lower than the maximum level specified in laser-safety standard IEC-60825-1.

In order to comply with this laser-safety standard, it is sought to ensure that the optical element 202 is present and operating correctly.

To this end, the optical element 202 is configured to generate, using the light source 201, a reference pattern 510 in the field of the image-capturing unit 300, and the control unit 400 is configured to identify the reference pattern 510 in the captured image 310.

Recognition of the reference pattern 510 in the expected location in the captured image 310 indicates not only that the optical element 202 is present as it should be, but also that it has not undergone degradation in the location in which the reference pattern 510 is generated. The expected location is for example the ceiling of the passenger compartment, which facilitates detection of its presence. However, the control unit may be configured to identify the reference pattern 510 on non-fixed parts of the image, such as a portion of the driver's body for example.

Use of components already present in the invention to verify the presence and operation of the optical element 202 makes it possible not to add new, bulky and/or expensive components.

According to one embodiment, the reference pattern 510 may be a hologram. For this purpose, the optical element 202 may comprise at least one holographic element allowing said hologram to be projected.

In the embodiment described here, the reference pattern 510 is a diffraction pattern. For this purpose, the optical element 202 comprises at least one diffractive element 203 designed to generate the reference pattern 510.

The diffractive element 203 may for example be a circular hole generating an Airy disk by way of reference pattern 510, as shown in FIG. 2. In another embodiment, the diffractive element 203 may be a rectangular hole; it then generates a diffraction pattern such as shown in FIG. 3.

The optical element 202 may also comprise complex diffractive elements such as multi-level pixel structures for example.

The dimensions of the diffractive element 203 depend on the conditions of use of the electronic device 100. For example, in the case of a circular hole, the dimensions of the Airy disk D_{airy} are calculated using the relationship:

$${D}_{airy} = 1.22 * lambda * d / phi ,$$

with lambda the wavelength of the light source 201, d the distance at which the reference pattern 510 is projected and phi the size of the diffractive element 203. Under the conditions described here, the wavelength used is for example 940 nm, and the reference pattern 510 is projected onto the interior roof of the motor vehicle, i.e. at a distance d=80 cm. To obtain an Airy disk of the order of 40 mm in diameter, the diameter of the diffractive element 203 is then of the order of 22 μm.

In the embodiment shown in FIG. 1, the diffractive element 203 is located in one place in the optical element 202.

If the optical element 202 moves with respect to the light source 201, a larger or smaller area of the diffractive element 203 will be illuminated. Thus, the brightness of the reference pattern 510 in the captured image 310 will then be modified. If the optical element 202 is absent, then the pattern will be absent from the captured image 310.

In another embodiment, provision may be made for there to be a plurality of diffractive elements 203. For example, provision may be made to position diffractive elements 203 all around the useful part of the optical element 202. The optical element 203 here comprises a central part and a peripheral region. The central part is used to spread the beam. The peripheral region comprises diffractive elements 203 and makes it possible to generate a plurality of diffraction patterns. A plurality of reference patterns 510 are then generated by the various diffractive elements in the captured image 310, respectively. Such an optical element 203 is shown in FIG. 4.

The control unit 400 may be configured to detect the various reference patterns 510 created by each of the diffractive elements 203. Thus, the control unit 400 will be able to detect which part of the optical element 202 is absent or damaged.

In one embodiment, identification of the pattern corresponds, for example, to finding the shape of the pattern. In another embodiment, identification may correspond to the shape and position of the pattern. It may also correspond to the shape, position and luminous intensity of the pattern.

Consequently, non-identification of the pattern may correspond to a degradation, movement or absence of the optical element 202 depending on the embodiments.

In the particular case where the control unit 400 fails to identify the reference pattern 510 in the captured image 310, said control unit 400 may activate a protective measure.

The protective measure may be to deactivate all or part of the light source 201 or to activate a degraded mode.

To facilitate detection of the reference pattern 510, said reference pattern 510 is preferably generated in a seldom used part of the captured image 310, in which the probability of an external element interfering with detection of the reference pattern 510 is low. For example, the reference pattern 510 is here generated on the roof of the passenger compartment 500 of the motor vehicle.

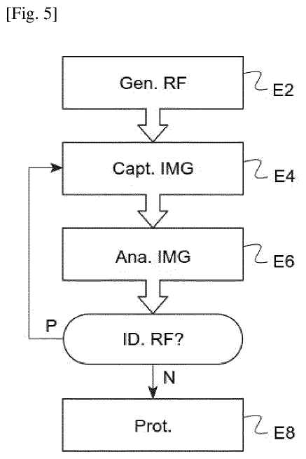

A method for monitoring for presence of an optical element 202 such as shown in the flowchart of FIG. 5 will now be described. Such a method is for example implemented by means of the electronic device 100. It comprises the following steps:
generating (E2) a reference pattern 510 at the exit of the optical element 202 by means of the illuminating unit 200;
capturing (E4) at least one image by means of the image-capturing unit 300;
analyzing (E6), by means of the control unit 400, the captured image 310 so as to identify the reference pattern 510.

If the analysis by the control unit 400 of the captured image 310 does not allow the reference pattern 510 to be identified (path N in FIG. 5), then the illuminating unit 200 may be defective, i.e. the optical element 202 may be absent or degraded.

The method for monitoring for presence of an optical element 202 may make provision for a protective measure (E8). This protective measure (E8) may be complete or partial deactivation of the light source 201. The protective measure (E8) may also be activation of a degraded mode in which an intensity of the light source 201 is reduced if the reference pattern 510 is not identified.

In case of activation of a degraded mode, the intensity of the light source 201 may for example be reduced to just below the maximum intensity level required to comply with laser standard IEC-60825-1.

If the reference pattern 510 is detected in the captured image 310 as it should be, then the optical element is indeed present and functional, and the method may then be repeated with another image (path P in FIG. 5).

The method may be carried out on each image as in the flowchart of FIG. 5, or at an image frequency such that the time of detection of the absence or degradation of the optical element 202 is less than a reference time. The reference time is specific to each electronic device 100 depending on its configuration, and may be defined as the maximum time for which the human eye is not affected by exposure to a defective illuminating unit 200.

The protective measure may be implemented as soon as the pattern is not detected for the first time, i.e. as soon as a captured image 310 makes it possible to conclude that the optical element 202 is absent or degraded. This is the case shown in FIG. 5.

Alternatively, the protective measure may be implemented when all the images captured 310 for a defined length of time less than the reference time make it possible to conclude that the optical element 202 is defective.

1. An electronic device comprising:
an illuminating unit;
an image-capturing unit; and
a control unit,
the illuminating unit comprising:
a light source, and
an optical element,
wherein the illuminating unit is configured to generate a reference pattern at an exit of said optical element; and
wherein the control unit is configured to analyze an image captured by the image-capturing unit,
wherein the control unit is configured to identify the reference pattern generated by the illuminating unit in the image captured by the image-capturing unit.

2. The electronic device as claimed in claim 1, wherein the reference pattern generated at the exit of said optical element is a diffraction pattern.

3. The electronic device as claimed in claim 1, wherein the optical element comprises at least one diffractive element.

4. The electronic device as claimed in claim 3, wherein the diffractive element of said optical element is a circular or rectangular hole.

5. The electronic device as claimed in claim 1, wherein the reference pattern generated at the exit of said optical element is a hologram.

6. The electronic device as claimed in claim 1, wherein the control unit is configured to activate a protective measure when the reference pattern is not identified.

7. The electronic device as claimed in claim 6, wherein the protective measure is complete or partial deactivation of the light source of the illuminating unit.

8. The electronic device as claimed in claim 6, wherein the protective measure is activation of a degraded mode in which a brightness of the light source is reduced.

9. The electronic device as claimed in claim 1, wherein said optical element is a diffuser.

10. The electronic device as claimed in claim 1, wherein the light source comprises at least one vertical-cavity surface-emitting laser.

11. The electronic device as claimed in claim 1, wherein the light source is an infrared source.

12. A method for monitoring for a presence of an optical element in an electronic device comprising:
an illuminating unit;
a control unit; and
an image-capturing unit,
the illuminating unit comprising:
a light source, and
the optical element; and
the monitoring method comprising:
generating a reference pattern at an exit of the optical element by the illuminating unit;
capturing at least one image by the image-capturing unit; and
analyzing, by the control unit, the captured image so as to identify the reference pattern.

13. The monitoring method as claimed in claim 12, comprising a protective measure if the reference pattern has not been identified.

14. The monitoring method as claimed in claim 13, wherein the protective measure is deactivation of the light source of the illuminating unit.

15. The monitoring method as claimed in claim 13, wherein the protective measure is activation of a degraded mode in which a brightness of the light source is reduced.
